(19) United States
(12) Patent Application Publication
(10) Pub. No.: US 2017/0244127 A1
(43) Pub. Date: Aug. 24, 2017

(54) IMPACT OF MEMBRANE CHARACTERISTICS ON THE PERFORMANCE AND CYCLING OF THE BR2-H2 REDOX FLOW CELL

(71) Applicants: Michael C. Tucker, Piedmont, CA (US); Kyu Taek Cho, Aurora, IL (US); Adam Z. Weber, Pleasant Hill, CA (US)

(72) Inventors: Michael C. Tucker, Piedmont, CA (US); Kyu Taek Cho, Aurora, IL (US); Adam Z. Weber, Pleasant Hill, CA (US)

(73) Assignee: The Regents of the University of California, Oakland, CA (US)

(21) Appl. No.: 15/052,640

(22) Filed: Feb. 24, 2016

(51) Int. Cl. H01M 8/18; H01M 8/1009; H01M 8/08; H01M 4/94; H01M 8/20; H01M 4/92

(52) U.S. Cl. CPC H01M 8/188; H01M 8/20; H01M 4/92; H01M 8/08; H01M 4/94; H01M 8/1009; H01M 2250/10

(57) ABSTRACT

Various embodiments may comprise an ion exchange membrane (IEM) redox flow cell comprising a IEM, a negative electrode in contact with a reactive fluid, a liquid electrolyte comprising reactants, a positive electrode in contact with the liquid electrolyte, and a diffusion barrier layer disposed between the IEM and the positive electrode, and wherein the negative electrode is isolated from the positive electrode by the IEM.

### CROSS REFERENCE TO RELATED APPLICATIONS

This application claims priority to U.S. Provisional Application Ser. No. 61/120,260 filed Feb. 24, 2015, which application is incorporated herein by reference as if fully set forth in their entirety.

### STATEMENT OF GOVERNMENTAL SUPPORT

The invention described and claimed herein was made in part utilizing funds supplied by the U.S. Department of Energy under Contract No. DE-AC02-05CH11231 between the U.S. Department of Energy and the Regents of the University of California for the management and operation of the Lawrence Berkeley National Laboratory. The government has certain rights in this invention.

### BACKGROUND OF THE INVENTION

### Field of the Invention

The Br₂/H₂ redox flow cell shows promise as a high-power, low-cost energy storage device. Membrane properties have a significant impact on the performance and efficiency of the system. In particular, there is a tradeoff between conductivity and crossover, where conductivity limits system efficiency at high current density and crossover limits efficiency at low current density.

### BRIEF DESCRIPTION OF THE DRAWINGS

FIG. 1a, FIG. 1b, and FIG. 1c illustrate effect of thickness for preboiled membranes: N117 (180 μm), NR212 (50 μm), and NR211 (25 μm). FIG. 1a illustrates Polarization behavior, FIG. 1b illustrates AC impedance, and FIG. 1c illustrates efficiency. Coulombic efficiency (thin lines), voltage efficiency (dashed lines), and energy efficiency (thick lines).

FIG. 2 illustrates crossover rate of water (squares) and bromine-species (triangles) at open circuit conditions for boiled NR212 membrane. Ratio of bromine and water crossover rates is also shown (circles).

FIG. 3 illustrates self-discharge at open circuit conditions for boiled NR212 membrane, with catholyte and hydrogen circulation. SOC vs. time determined from mapping of the OCV vs. SOC onto the OCV vs. time data shown in the inset.

FIG. 4a and FIG. 4b illustrate water crossover for boiled NR212 membrane as a function of charge current density and SOC. Discharge data (at 500 mA cm⁻²) is indicated in the figures. FIG. 4a illustrates water crossover rate, and FIG. 4b illustrates electro-osmotic coefficient.

FIG. 5a and FIG. 5b illustrate total bromine-species crossover for boiled NR212 membrane as a function of charge current density and SOC. Discharge data (at 500 mA cm²) is indicated in the figure. FIG. 5a illustrates Bromine crossover rate, and FIG. 5b illustrates ratio of crossover rates for bromine and water (from FIG. 4).

FIG. 6. Initial polarization performance for various as-received membranes.

FIG. 7a, FIG. 7b, and FIG. 7c illustrate the effect of pretreatment for NR212 membranes: As-received, boiled, and soaked in 70° C. water. FIG. 7a illustrates polarization behavior, FIG. 7b illustrates the AC impedance, and FIG. 7c illustrates the efficiency. Coulombic efficiency (thin lines), voltaic efficiency (dashed lines), and energy efficiency (thick lines).

FIG. 8a, FIG. 8b, and FIG. 8c illustrate the impact of swelling state (extent of hydration) during cell assembly for NR212: as-received dry, as-received wet, boiled dry, and boiled wet. FIG. 8a illustrates the polarization behavior, FIG. 8b illustrates the efficiency for as-received membrane, and FIG. 8c illustrates the efficiency for boiled membrane. Coulombic efficiency (thin lines), voltaic efficiency (dashed lines), and energy efficiency (thick lines).

FIG. 9a and FIG. 9b illustrate the impact of swelling state (extent of hydration) during cell assembly for Gore M60111PC reinforced membrane: as-received dry and as-received wet. FIG. 9a illustrates the polarization behavior and FIG. 9b illustrates the efficiency. Coulombic efficiency (thin lines), voltaic efficiency (dashed lines), and energy efficiency (thick lines).

FIG. 10a and FIG. 10b illustrate the influence of addition of a microporous separator between a boiled NR212 membrane and the (+) electrode. FIG. 10a illustrates the polarization performance, and FIG. 10b illustrates the coulombic efficiency (thin lines), voltaic efficiency (dashed lines), and energy efficiency (thick lines) and without microporous separator.

FIG. 11a, FIG. 11b, and FIG. 11c illustrate the cycling with mechanical return of crossover liquid for NR212 pre-soaked at 70° C. in water. FIG. 11a illustrates the capacity and efficiencies, and comparison of FIG. 11b the cell polarization performance and FIG. 11c the AC impedance spectra at selected times.

FIG. 12a illustrates a bromine-hydrogen cell structure.

FIG. 12b illustrates a bromine-hydrogen cell structure further comprising a diffusion barrier layer.

FIG. 13a and FIG. 13b illustrate a typical performance and efficiency behavior of the bromine-hydrogen redox flow cell.

### DETAILED DESCRIPTION

In the discussions that follow, various process steps may or may not be described using certain types of manufacturing equipment, along with certain process parameters. It is to be appreciated that other types of equipment can be used, with different process parameters employed, and that some of the steps may be performed in other manufacturing equipment without departing from the scope of this invention. Furthermore, different process parameters or manufacturing equipment could be substituted for those described herein without departing from the scope of the invention.

These and other details and advantages of the present invention will become more fully apparent from the following description taken in conjunction with the accompanying drawings.

Various embodiments of the invention describe the effect of various aspects of material selection and processing of proton exchange membranes on the operation of the Br₂/H₂ redox flow cell.

The impact of thickness, pretreatment procedure, swelling state during cell assembly, equivalent weight, membrane reinforcement, and addition of a microporous separator layer on this tradeoff is assessed. An NR212 (50 μm) membrane pretreated by soaking in 70° C. water is found to be optimal for the studied operating conditions. For this case, an energy efficiency of greater than 75% is achieved for current density up to 400 mA cm⁻², with a maximum obtainable energy efficiency of 88%. A cell with this membrane was cycled continuously for 3164 h. Membrane transport properties, including conductivity and bromine and water crossover, were found to decrease moderately upon cycling but remained higher than those for the as-received membrane.

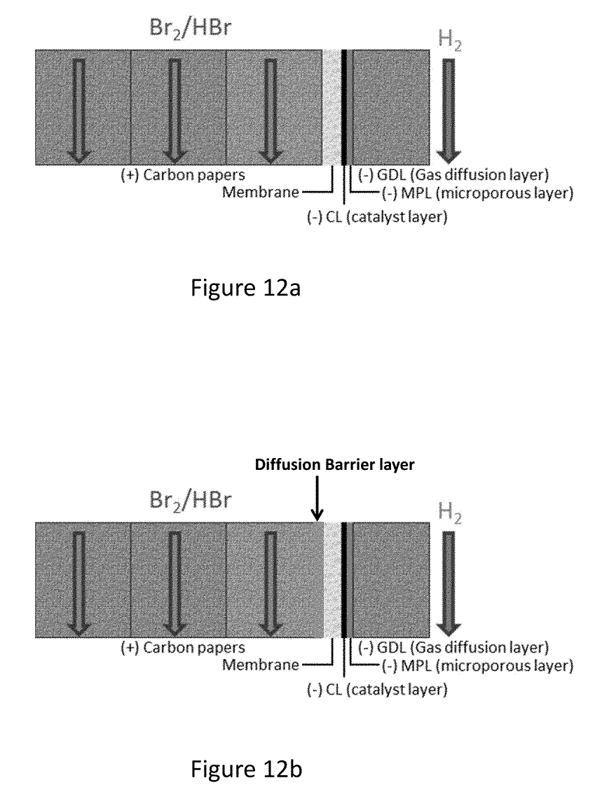

The Br₂/H₂ redox flow cell is a promising system for large-scale energy storage due to its high power and potential for low installed system cost. The system consists of an electrochemical cell which is fed reactants from storage tanks containing gaseous hydrogen (negative side) and an aqueous solution of Br₂ and HBr (positive side) (see FIG. 12). During discharge, hydrogen is oxidized to protons at the negative electrode (platinum Pt catalyst). The protons pass through an ion-conducting membrane and react with Br₂ at the positive electrode to produce HBr. The electrochemical reactions are shown below with the forward direction corresponding to discharge and the reverse to charge.

Negative: H₂(g) [symbol] 2H⁺(aq)+2e⁻E⁰=0.00V (1)

Positive: Br₂(aq)+2e⁻ [symbol] 2Br⁻(aq)E⁰=1.09V (2)

Overall: Br₂(aq)+H₂ [symbol] 2HBr(aq)E⁰=1.09V (3)

The membrane is a critical component of the cell, as it allows protons to pass between the electrodes to complete the electrochemical reactions, while limiting the transport of electrons and redox reactants/products across the cell. The minimum requirements for the membrane are proton ionic conductivity and electronic resistance to prevent the formation of a short-circuit between the electrodes. Kinetics in this system are facile, so the membrane ohmic resistance is a dominant source of cell polarization. Use of a thin membrane was shown to greatly increase cell performance, and 0.9 and 1.4 W cm⁻² were achieved for 50 and 15 μm-thick electrolyte membranes, respectively. It is also desirable for the membrane to minimize mixing between hydrogen and the (+) electrolyte solution as noted above. Therefore, key properties of the membrane include permeability of water, hydrogen, and bromine-species, and electro-osmotic coefficient. Crossover of bromine-species through the membrane to the (−) electrode is the main cause of self-discharge in this system, and dominates coulombic and energy efficiencies at low current density. The presence of bromide at the (−) electrode can also lead to poisoning and corrosion of the Pt catalyst. The desire for high conductivity and low crossover establishes a tradeoff when selecting the optimal membrane thickness. Various embodiments of the invention elucidate the impact of these properties on system performance and efficiency, and how membrane parameters such as thickness, pretreatment, and equivalent weight affect the tradeoff.

Various approaches to membrane selection and improvement have been undertaken. Livshits et al. demonstrated power density greater than 1 W cm⁻² using a nanoporous membrane composed of polyvinylidene difluoride (PVDF) with silica to promote hydrophilicity. Although the membrane was 60% porous, it was thick enough (100 μm) that solution crossover through the pores was manageable. Composite membranes composed of conventional proton exchange membrane (PEM) material (e.g. Nafion) mixed with inactive polymer via electrospinning have been developed. Such membranes have shown improved selectivity of protons vs. bromine species and reduced materials cost relative to pure-PEM membranes. Even cells with no membrane that rely on laminar flow profiles to minimize intermixing of the reactant streams have been successfully demonstrated. In various embodiments of the invention, we focus on commercially-available PEM membranes and examine property changes related to their pretreatment. The water and proton transport properties of these materials are well-understood from their application in low-temperature fuel cells, their chemical compatibility with hydrogen and acidic/oxidizing species is established, and PEM membranes are widely used in flow cells with other energy-storage chemistries. However, for many of these applications, the understanding of the impact of crossover versus energy efficiency in terms of properties is not well explored, as experience with low-temperature fuel cells is typically at higher temperatures and current densities than flow cells.

### 2. Experimental Methods

Cells were assembled and tested using Fuel Cell Technologies hardware and equipment discussed in detail elsewhere. Metallic flowfields were provided by Treadstone Technologies, Inc. The (+) electrode material was a Sigracet gas diffusion layer (GDL) 10AA carbon paper (SGL Group) treated in concentrated sulfuric acid for 10 hours at 50° C. The (−) electrode was 0.4 mg cm⁻² Pt/C printed on Sigracet GDL 24BC gas diffusion layer (GDL), provided by Ion Power. Membranes were used as-received, or pretreated by either hot-soaking in DI water for 3 h at 70° C., or by boiling successively in 3% H₂O₂, DI water, 0.5 M sulfuric acid, and DI water for 1 h each.

Cells were operated with dry hydrogen (200 sccm) and 0.9 M Br₂/1.0 M HBr 97% state of charge (SOC) solution (˜100 ml min⁻¹), except in Section 3.2 where SOC was adjusted by decreasing the Br₂:HBr ratio while maintaining total bromine-atom concentration constant. Hydrogen pressure was controlled with a backpressure regulator on the cell exhaust line. Polarization curves were obtained using a Maccor 4200 battery tester. AC impedance (at open circuit voltage) and cycling efficiency curves (according to a protocol discussed elsewhere) were obtained with a Bio-Logic VMP3 potentiostat. Cells were initialized by current-step cycling (50 mA cm⁻² steps of 30 sec) five times between voltage limits of 0.2 to 1.8 V before recording the data shown here (50 mA cm⁻² steps for 10 sec). Stable polarization behavior was typically achieved on the third such cycle.

Membrane conductivity was assessed at open-circuit and 97% SOC conditions using AC impedance (positive electrode as working electrode, 5 mV perturbation amplitude, ohmic impedance taken as the high-frequency intercept with the x-axis). Contact resistance of the other cell components was estimated by assembling a cell without a membrane and found to be 0.05 Ohm-cm². This value was subtracted from the total cell ohmic impedance to determine the membrane's ohmic impedance. Self-discharge rate was determined by cycling the cell from 0.5 to 1.2 V at 75 mA cm⁻². The difference between charge and discharge capacity was used to calculate self-discharge rate.

Crossover rate for water and bromine-species was determined by collecting the liquid exiting the (−) exhaust. The exit line was cooled to 0.5° C. to condense water and bromine vapor. The collected liquid was then analyzed for bromide content using a bromide-selective electrode, with the electrode and Reference Sensor (DX200 and DX280, Mettler Toledo) connected to an ORION 4 STAR datalogger (Thermo SCIENTIFIC). Electrolytes (1 M KNO₃ and 3 M KCl) and ionic strength adapter (5 M sodium nitrate) were provided by Mettler Toledo. Sodium bromide (99.7%, ACS Reactant, J. T. Baker) dried for two hours at 120° C. in an environmental chamber (VWR Symphony) was used as a calibration standard. All measurements were performed at room temperature.

Small differences in measured properties exist when comparing membranes characterized in different cell builds (for example the properties for as-received NR212 membranes listed in Tables 1 and 2 vary somewhat). This is due to experimental error and batch-to-batch variations in membrane and non-membrane components (for example GDL thickness and therefore compression), as the data were collected over many months with various batches of materials from the suppliers. Note however, that all data presented within a single Figure or Table used identical batches (for example all membrane types compared in Table 1 were evaluated with the same batch of GDL material).

TABLE 1
Properties of various membranes in the as-received state, and NR212 subjected to pretreatment procedures.

| | | | | | | Electro-osmotic | | | |
|---|---|---|---|---|---|---|---|---|---|
| | | | | | | Coefficient | Br/H⁺ | Br/H₂O | Self- |
| | Equivalent | Thickness^{a} | Conductivity^{b} | Water Flux^{c} | Br Flux^{c} | H₂O/H⁺ | (mmol | (mmol | Discharge^{d} |
| | Weight | (μm) | (mS cm⁻¹) | (mg h⁻¹ cm⁻²) | (mg h⁻¹ cm⁻²) | (mol mol⁻¹) | mol⁻¹) | mol⁻¹) | (mA cm⁻²) |
| 3M 825EW AR | 825 | 82 | 94 | 478 | 13 | 1.4 | 9 | 6 | 0.7 |
| Aquivion | 870 | 53 | 78 | 469 | 16 | 1.4 | 11 | 8 | 1.0 |
| E87-05S AR | | | | | | | | | |
| Aquivion | 980 | 42 | 42 | 428 | 11 | 1.3 | 7 | 6 | 1.2 |
| E98-05 AR | | | | | | | | | |
| Gore | 1100 | 66 | 46 | 469 | 9 | 1.4 | 6 | 5 | 0.9 |
| 60111PC AR | | | | | | | | | |
| NR212 AR | 1100 | 55 | 59 | 448 | 10 | 1.3 | 7 | 5 | 1.5 |
| NR212 70° C. | 1100 | 56 | 80 | 790 | 34 | 2.4 | 23 | 10 | 3.4 |
| NR212 Boiled | 1100 | 60 | 95 | 1040 | 66 | 3.4 | 44 | 13 | 13.1 |

^{a}After soaking in 0.9M Br₂, 1M HBr for 24 h
^{b}Determined from ohmic portion of AC impedance, corrected for contact resistances, 0.9M Br2, 1M HBr
^{c}Determined at 500 mA cm⁻² charge current and 97% SOC
^{d}Determined from a complete charge/discharge cycle (0.5-1.2 V) at 75 mA cm⁻²

Cell cycling was conducted in battery mode, with closed catholyte and hydrogen loops. A glass reservoir held hydrogen that was circulated through the cell and returned to the reservoir through a liquid trap. The accumulated liquid was pumped to the catholyte tank several times per cycle, at a rate selected to match the average crossover flux. The hydrogen tank was held at roughly ˜136 kPa absolute pressure, and the pressure fluctuated slightly during charging and discharging; excess hydrogen was used to minimize the pressure variation. Assessment of performance and properties was conducted as described above, with the hydrogen cell exhaust vented rather than circulated. The membrane was pretreated by 70° C. hot soaking, and had carbon (+) and Pt/C (−) catalyst layers printed on the membrane. The (−) GDL was Sigracet GDL 25BC.

Platinum dissolution from the Pt/C (−) electrode was determined by analyzing the platinum content of the catholyte after long-term cycling. Inductively coupled plasma optical emission spectroscopy (ICP-OES) was used for the analysis (Perkin-Elmer Optima 5300 DV). Standard solutions were obtained by diluting a commercial 1000 ppm Platinum solution (Aristar Plus, VWR International) with DI-water. Prior to the analysis, bromine was removed from the catholyte solutions via treatment with 1:1 30% hydrogen peroxide solution to oxidize bromide and subsequent bubbling with oxygen while heated to 70° C. for several hours to evaporate bromine. The evaporation was stopped when the solution volume reached its original amount. Since the measured platinum concentrations using the original sample volume were fairly close to the detection limit, the catholyte solutions were concentrated 8-fold by evaporation to confirm the measurement results. Nitric acid was added to all standards and catholyte solutions to achieve a concentration of 0.2% in the samples.

### 3. Results and Discussion

### 3.1 Impact of Membrane Thickness

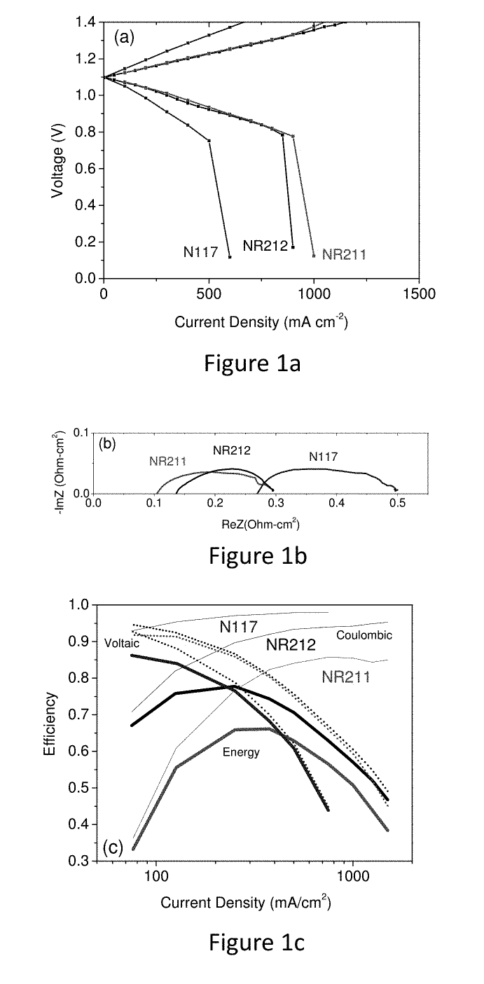

The performance and efficiency of a cell with preboiled Nafion membranes of various thicknesses is shown in FIG. 1. The polarization behavior is qualitatively consistent with previous reports. In particular, the charge and discharge polarization is linear, suggesting it is dominated by ohmic losses with minimal kinetic overpotential, and upon discharge there is a sharp limiting current arising from bromide adsorption on Pt at the (−) electrode. Note the last data point on each discharge curve is not a stable operation point, but represents where the voltage cutoff was engaged due to bromide adsorption. The polarization slope for N117 (180 μm thick) is significantly higher than for the thinner membranes. This is consistent with the significantly higher ohmic impedance for the thicker membrane, as determined by AC impedance (FIG. 1b). The polarization slope for NR212 (50 μm thick) and NR211 (24 μm thick) are quite similar. AC impedance reveals that although the ohmic impedance is lower for the thinner membrane (as expected), the non-ohmic polarization is higher. This may arise from higher liquid crossover to the (−) electrode via permeation, resulting in polarization due to flooding or increased Br⁻ concentration at the Pt electrode.

FIG. 1c shows the impact of membrane thickness on efficiency. A detailed discussion of how the efficiency data are obtained is available in Ref. The energy efficiency is limited by reduced voltaic efficiency arising from cell polarization at high current density, and by reduced coulombic efficiency at low current density due to self-discharge via crossover of bromine through the membrane. The high polarization for the N117 membrane dramatically reduces voltage efficiency compared to the thinner membranes. The self-discharge rate is a strong function of membrane thickness as well: 3 mA cm⁻² for N117, 13 mA cm⁻² for NR212 and 35 mA cm⁻² for NR211. The low self-discharge rate for N117 leads to high coulombic efficiency at all current densities studied, which enables an energy efficiency above 0.8, albeit at low current density. In contrast, the high self-discharge rate for NR211 leads to coulombic efficiency below 0.85 over the entire range of current density, and a maximum energy efficiency of only 0.65. The behavior for NR212 was intermediate to the others, with a self-discharge rate of 13 mA cm⁻² and a broad energy efficiency peak providing >0.7 for a wide window of current density. For this reason, NR212 was selected for further studies.

### 3.2 Crossover

Uptake of water and dissolved species from the contacting liquid electrolyte is inherent to the proton exchange membrane (PEM) structure. Crossover of water and bromine species occurs via transport through the membrane hydrophilic channels, driven by concentration, pressure, and/or ionic-potential gradients. In redox flow cells with liquids on both sides of the membrane (such as the vanadium redox flow battery), crossover occurs in both directions depending on the current direction and compositions of the electrolytes. In the present system, the (−) electrode is fed with hydrogen gas, and it is found that crossover generally occurs in the direction from (+) to (−) electrodes. We have assessed crossover rates for water and bromine species by collecting exhaust from the (−) electrode of a cell with preboiled NR212 membrane. Dry hydrogen is fed to the cell and the (−) exhaust is passed through a condenser to capture water and bromine species that crossed over. The collection rate of the liquid is recorded to assess water crossover, and the Br⁻ concentration of the liquid is analyzed with a bromide-selective electrode to determine bromine crossover rate. Note that all bromine species (Br₂, Br₃⁻, etc.) are converted to Br⁻ at the (−) electrode, therefore, the bromine mass flux (reported in mg h⁻¹ cm⁻²) includes crossover of all bromine species (we do not attempt to determine speciation of bromine in the membrane). In contrast, self-discharge rates (reported in mA cm⁻²) relate only to crossover of oxidized bromine species, which are reduced at the (−) electrode; Br⁻ crossover does not appear in the self-discharge rate as it does not contribute to coulombic efficiency loss.

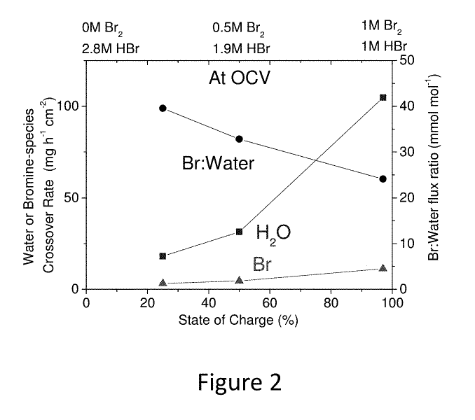

In the absence of cell current, crossover is driven by diffusion and permeation through the membrane. Crossover rates at open-circuit voltage (OCV) conditions are shown in FIG. 2 for various states of charge (SOC); 0% SOC corresponds to 0M Br₂/2.8 M HBr and 100% SOC is roughly 0.93 M Br₂/0.93 M HBr. Both water and bromine crossover increase with SOC. This is consistent with reduced diffusion due to dehydration of the membrane which is known to occur at low SOC (high HBr concentration). The Br:water ratio decreases with SOC, but never reaches the ratio present in the bulk catholyte (54 mmol mol⁻¹). This suggests some partitioning of bromine species between the catholyte and membrane channels. As the SOC increases, the fraction of bromine present as large complexes (Br₃⁻ etc.) increases, and we surmise that size exclusion decreases the amount of bromine-species entering the membrane. Donnan exclusion may also play a role in partitioning, as both bromide ion and bromide complexes are negatively charged (same as the SO₃⁻ groups in the PEM), and thus transport is probably of condensed HBr-type species.

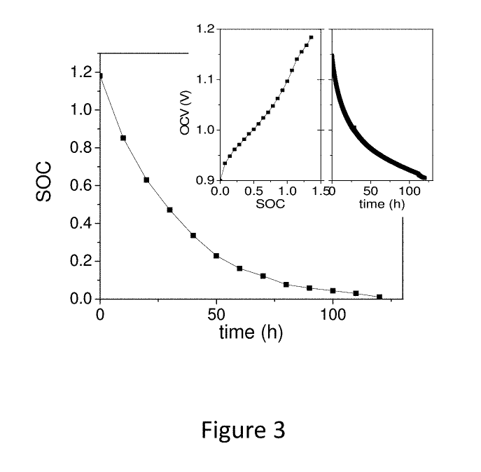

FIG. 3 tracks SOC as a cell undergoes self-discharge at OCV. The cell was charged with periodical current interrupts to record OCV vs. SOC. Note that SOC is defined to equal unity at a Br₂:HBr molar ratio of 1:1. It is possible to charge the solution above this ratio, with liquid bromine being produced as a second phase. This condition is generally avoided in this work, however the data in FIG. 3 are an exception. The cell was intentionally over-charged only slightly past the equimolar ratio; thus the OCV vs. SOC curve does not curve up at high SOC because complete conversion of bromide to bromine does not occur. The cell then rested at OCV for ˜120 h during which Br₂/HBr electrolyte and hydrogen were circulated continuously and OCV was recorded. Combining the data from these two runs (shown in the inset) produced a mapping of SOC vs. time during self-discharge at OCV. It is clear that the self-discharge rate is highest at high SOC (high Br₂ concentration) and decays as Br₂ is consumed; this supports a conclusion that self-discharge arises from Br₂ crossover. This suggests a number of strategies for decreasing self-discharge, including restricting operation to low SOC or increasing bromide concentration to increase complexation of Br₂ (thereby promoting size exclusion of Br₂).

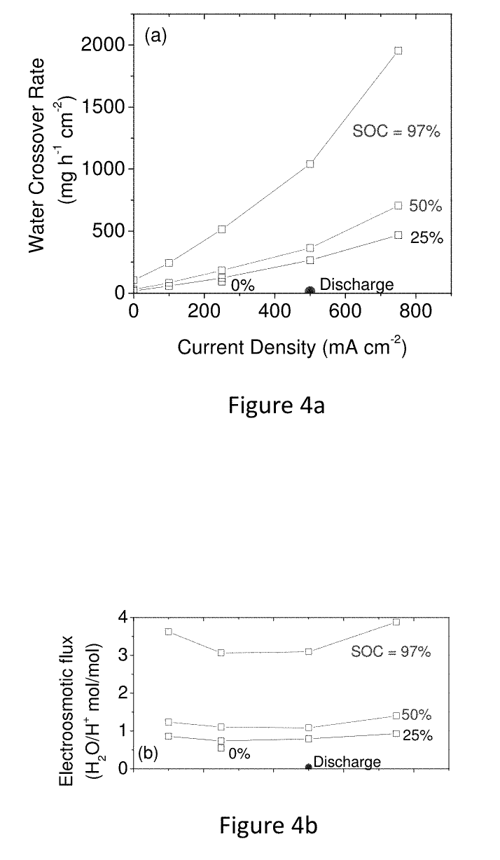

The application of current introduces migration and electro-osmotic flux as additional mechanisms for crossover of water and bromine-species. FIG. 4 shows water crossover rate as a function of charge current density at various SOC. The water crossover rate increases significantly as charge current density increases, suggesting electro-osmosis dominates over diffusion. The electro-osmotic coefficient (FIG. 4b) depends strongly on SOC, increasing at higher SOC. This is consistent with membrane dehydration, which increases with HBr concentration (which is higher at lower SOC). The slight increase in the electro-osmotic coefficient at higher current density is also related to membrane dehydration; at high current, the local HBr concentration adjacent the membrane is lower, resulting in reduced dehydration. The increase at low current density is an artifact; additional water crossover arising from diffusion and permeation was not corrected for in the calculation of the electro-osmotic coefficient, but is significant at low current density. The crossover rate during discharge was measured only at 500 mA cm⁻². The amount of crossover liquid was lower than that at OCV and negligible for all SOC, suggesting that electro-osmosis (towards the (+) electrode) overcomes diffusion and permeation during discharge.

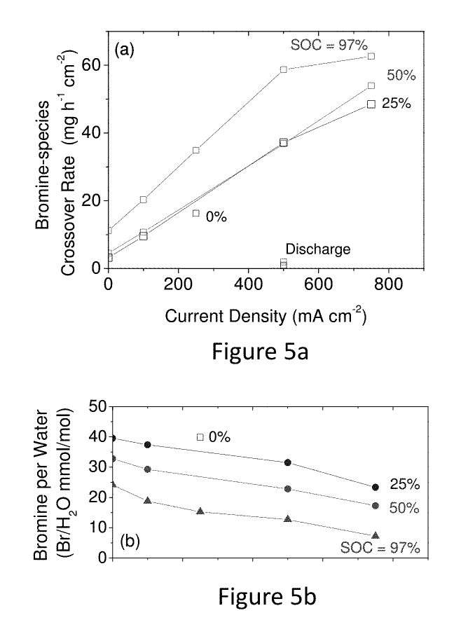

Analysis of the crossover water provides total bromine-species crossover rate as discussed above. The behavior of the bromine-species crossover rate (FIG. 5a) is qualitatively similar to the water crossover rate (compare to FIG. 4a), suggesting bromine-species in solution accompany the crossover water. The bromine-to-water crossover ratio is shown in FIG. 5b to generally decrease with SOC and current density. This is consistent with transport of Br-complexes being hindered in the membrane relative to Br⁻ transport, presumably by size exclusion: complexation increases with SOC, and the local SOC at the membrane surface is expected to increase with current density. In all cases studied here, the bromine-per-water ratio in the crossover liquid is lower than in the bulk catholyte (54 mmol mol⁻¹), so bromine is retained in the bulk solution as liquid transports through the membrane.

Comparison of the crossover rates for various membrane types and treatments is discussed below. A single operating condition, based on the results of FIGS. 4 and 5, was chosen to expedite comparison. Charge at 97% SOC and 500 mA cm⁻² was chosen because it provides a high crossover rate, for ease of collection and accuracy measurement in a short time, and the current density is relevant to high-efficiency cycling (see for example the data for NR212 in FIG. 1c).

For all operating conditions studied, including charge, discharge, open circuit, and various SOC, net transport of water and bromine-species is from the (+) to (−) electrode. Therefore, crossover liquid must be collected and returned to the catholyte tank to ensure stable system operation, but this increases expense and complexity of the system. Methods to minimize the amount of crossover are discussed below.

### 3.3 Performance of Various Membrane Types

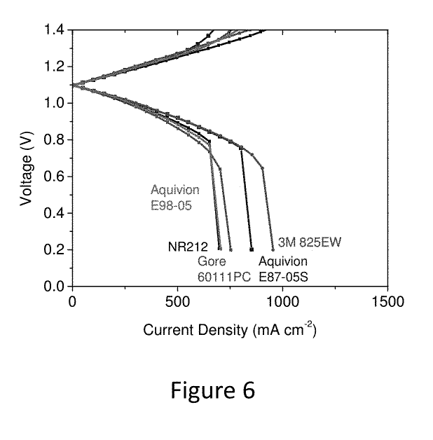

A range of perfluorosulfonic acid (PFSA)-based PEM membranes were obtained from various vendors and compared in the as-received state for conductivity, water and bromine-species crossover, self-discharge rate, and initial performance. The Gore membrane is a composite, including an extended-PTFE mesh for mechanical reinforcement, which reduces bulk transport properties and in-plane swelling. The other membranes are homogeneous PFSA, but vary in their equivalent weight or side-chain length. It is known from the PEM fuel cell literature that lower equivalent weight (higher ion-exchange capacity) provides increased transport properties, but at the expense of mechanical properties. Of the membranes studied, Aquivion E87-05S and 3M 825EW had the lowest equivalent weights. As expected, they also displayed the highest conductivity and bromine-species and water fluxes (Table 1). Their initial performance was also better than the others as shown in FIG. 6. It should be noted that the impact of equivalent weight and reinforcement on all measured properties and performance is quite small compared to the impact of pretreatment and membrane thickness discussed below.

### 3.4 Impact of Membrane Pretreatment

Thermal pretreatment of the membrane is expected to affect its properties, including proton conductivity and uptake of water and other species. Here, we compare an NR212 membrane in the as-received state (no treatment), as a pre-treated before cell assembly by hot-soaking in 70° C. water, or as a successive boiling in peroxide, water, and dilute sulfuric acid. As shown in Table 1, conductivity is improved 35% by hot-soaking, and marginally more by boiling. The impact of pretreatment on crossover is more dramatic. Hot-soaking almost doubles the water crossover and increases total Br flux three-fold. Boiling almost triples water crossover and increases Br flux six-fold. The self-discharge rate, which derives from crossover of Br₂-containing species, follows a similar trend as the total Br flux. It is interesting to note that bromine-species crossover greatly outpaces the increase in water crossover as the pretreatment temperature increases. This is consistent with size exclusion being the main driver for partitioning of bromine complexes between the catholyte and membrane; channel size is known to increase with pretreatment.

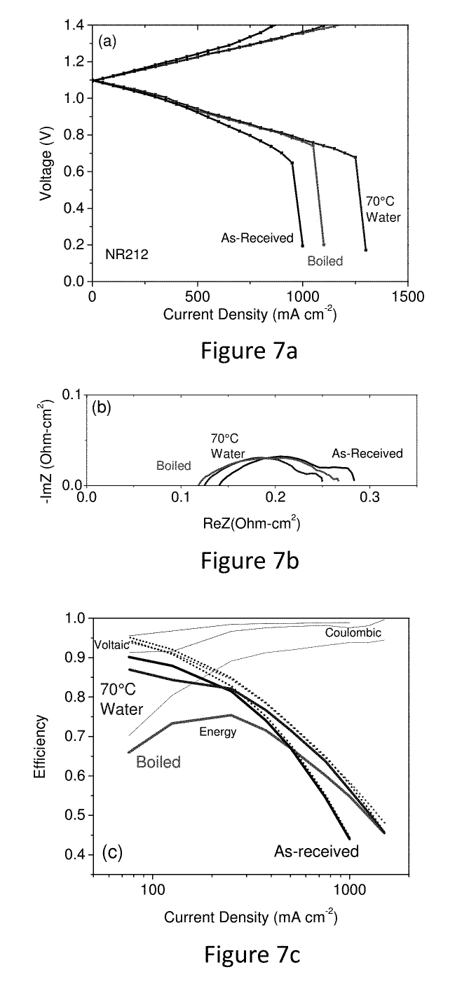

The impact of membrane treatment on performance is shown in FIG. 7. Both pretreatment procedures provide improved polarization relative to the as-received membrane, primarily by increasing the membrane conductivity as shown by AC impedance (FIG. 7b). Boiling improved conductivity slightly more than hot-soaking, but also increased non-ohmic polarization. This may arise from higher liquid crossover to the (−) electrode, resulting in polarization due to flooding or increased Br⁻ concentration at the Pt catalyst sites, which would also account for the reduced limiting current on discharge relative to hot-soaking.

Both the crossover rate and polarization performance influence the efficiency behavior as shown in FIG. 7c. Relative to the as-received baseline, both pretreatments are effective at increasing voltaic efficiency at high current density, consistent with the similar polarization behavior in FIG. 7a. The high bromine crossover for the boiled membrane dramatically reduces coulombic efficiency at low current density. The above tradeoffs lead to a maximum energy efficiency of 0.75 (at 250 mA cm⁻²) for the boiled membrane. In contrast, the as-received membrane maintains coulombic efficiency above 0.95 for all current densities examined; high energy efficiency of 0.9 is obtained at 75 mA cm⁻². Hot-soaking only moderately decreases coulombic efficiency, and increases voltaic efficiency, leading to a small increase in the maximum current density for which >0.75 energy efficiency can be achieved. For this reason, hot-soaking was chosen as the treatment prior to long-term cycling discussed below in Section 3.7.

Based on these findings, and the desire to eliminate pretreatment from the cell assembly process, it is recommended to use membranes in the as-received state to maximize efficiency. Boiling the membrane does not offer any clear benefits for initial performance.

### 3.5 Impact of Swelling State (Extent of Hydration) at Cell Assembly

The swelling state of PEM membranes depends strongly on water content. As a dry membrane becomes wet it swells in all dimensions and the dimensional change can be quite large. Likewise, as a wet membrane dries it shrinks. It is expected that the swelling state impacts membrane transport properties, as the density of 50₃⁻ groups, water content, and hydrophilic channel size all change as the membrane shrinks or expands. Furthermore, mechanical compression is known to affect swelling and conductivity in PEM membranes. In an operating cell, the membrane is compressed between gaskets and electrodes, and the size is mechanically constrained; the membrane is not free to shrink or expand in response to changing conditions such as moisture content. Therefore, the extent of membrane swelling is “locked in” during cell assembly and whether the membrane is dry or wet during assembly strongly affects transport properties and cell performance as shown below.

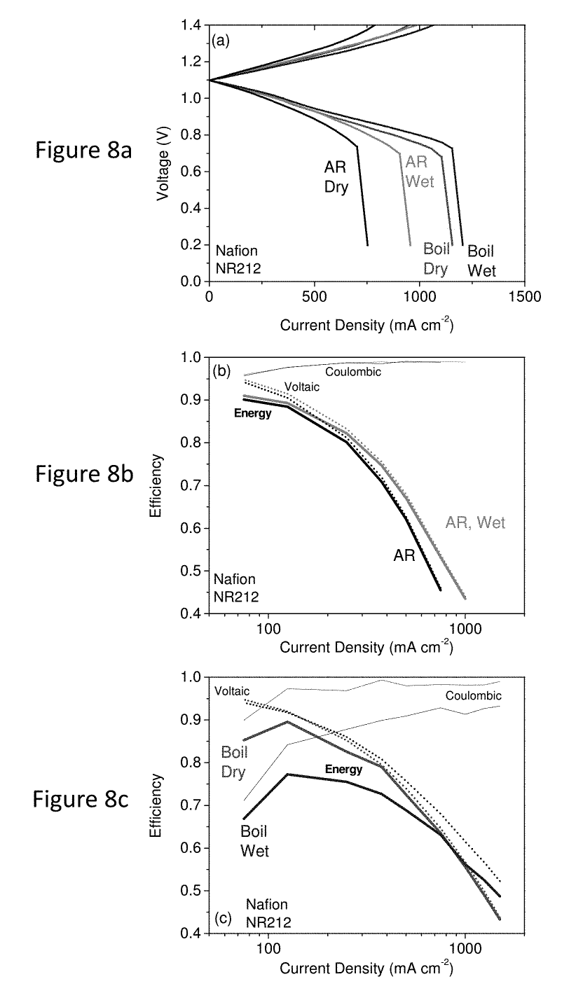

For Nafion NR212 it was found that dry, as-received membranes swell 6% in-plane after soaking in water for a few minutes, and wet, pre-boiled membranes shrink 14% upon drying in ambient air. For both as-received and boiled NR212, Table 2 shows that assembling in the wet state leads to increased transport properties, and the effect is more pronounced for the boiled case. Polarization performance also increases for the wet cases as shown in FIG. 8a. For as-received NR212 (FIG. 8b), the increase in bromine transport accompanying assembly in the wet state impacts the coulombic efficiency minimally, as the self-discharge rate for both cases is quite small. The increased performance for the wet-assembled membrane, however, significantly increases voltaic efficiency. Energy efficiency is therefore improved by wetting the as-received membrane before assembly. In contrast, the greatly reduced self-discharge rate accompanying drying of the boiled NR212 before assembly leads to significantly improved coulombic efficiency, which overshadows the small decrease in voltaic efficiency (FIG. 8c). Energy efficiency is therefore improved by drying the boiled membrane before assembly. Re-wetting the boiled, dried membrane before cell assembly returns the properties nearly to the boiled, wet case (data not shown).

TABLE 2
Impact of swelling state (extent of hydration) during cell assembly for
boiled and as-received NR212, and as-received reinforced Gore membrane.

| | | | | Electro-osmotic | | | |
|---|---|---|---|---|---|---|---|
| | | | | Coefficient | Br/H⁺ | Br/H₂O | Self- |
| | Conductivity | Water Flux | Br Flux | H₂O/H⁺ | (mmol | (mmol | Discharge |
| | (mS cm⁻¹) | (mg h⁻¹ cm⁻²) | (mg h⁻¹ cm⁻²) | (mol mol⁻¹) | mol⁻¹) | mol⁻¹) | (mA cm⁻²) |
| NR 212 Boil Dry | 97 | 672 | 25 | 2.0 | 17 | 8 | 3.8 |
| NR212 Boil Wet | 149 | 986 | 55 | 2.9 | 37 | 13 | 12.3 |
| NR212 AR Dry | 66 | 448 | 10 | 1.3 | 7 | 5 | 1.4 |
| NR212 AR Wet | 75 | 511 | 14 | 1.5 | 9 | 6 | 1.5 |
| Gore | 43 | 475 | 10 | 1.4 | 7 | 5 | 1.4 |
| 60111PC AR Dry | | | | | | | |
| Gore | 48 | 517 | 11 | 1.5 | 7 | 5 | 1.4 |
| 60111PC AR Wet | | | | | | | |

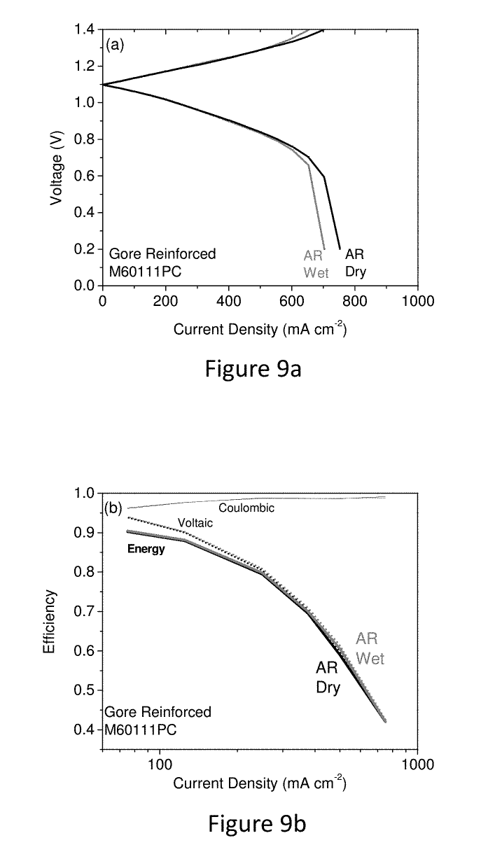

The impact of wetting as-received PTFE-reinforced membrane before assembly is shown in FIG. 9. In this case, reinforcement precludes significant in-plane swelling for all moisture states; the membrane swelled less than 1% upon wetting. Wetting this membrane before assembly has almost no impact on performance or efficiency. This confirms that the large effect seen for NR212 above is related to dimensional swelling, and not simply to whether the membrane is hydrated or not before assembly.

For a non-reinforced membrane, assembling the cell with a dry membrane and then wetting it during cell operation leads to stress in the active area of the membrane. We speculate that the stress will eventually overcome the mechanical constraint and cause the membrane to equilibrate to the wet, swelled state via creep or other relaxation processes. Therefore, the impact of membrane state during assembly reported here is considered to be relevant to initial performance, and may not persist for the entire lifetime of the device. Future long-term testing will be needed to elucidate the longevity of this feature of membrane behavior.

### 3.6 Dual Membrane

Crossover of bromine species decreases as the concentration in the catholyte decreases [3]. This is expected to hold for all crossover mechanisms, including diffusion, permeation, and electro-osmosis due to the nonlinear interactions between the concentration and membrane morphology. Reducing bromine-species concentration, however, comes at the expense of energy-storage capacity. Therefore, we propose the use of a dual membrane as an alternative method of reducing crossover while maintaining bromine-species concentration.

The dual membrane consists of a PEM with an additional microporous membrane inserted between the PEM and (+) electrode. The microporous membrane serves as a diffusion barrier to bromine-species, and also physically blocks a fraction of the PEM area from being exposed to the catholyte. The area-averaged concentration of bromine-species at the PEM surface is thus reduced, thereby reducing crossover through the PEM. Of course, the additional ion-conduction path length through the microporous separator will increase the ohmic loss in the cell.

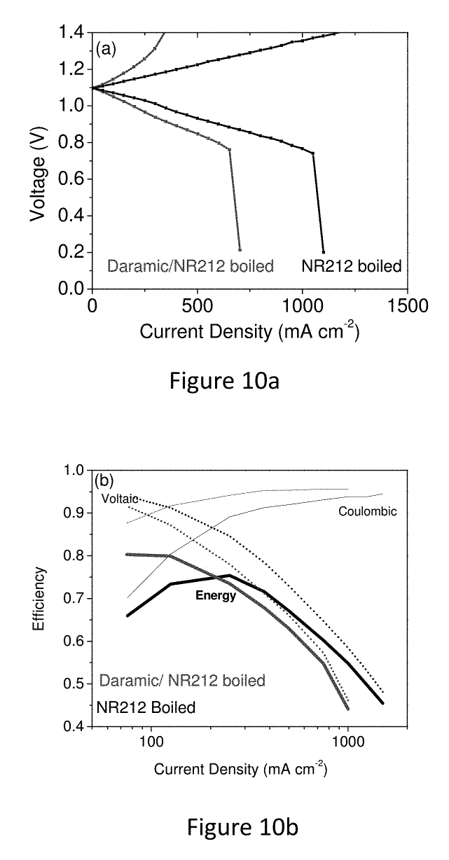

FIG. 10 shows the impact of adding a Daramic microporous separator to a boiled PEM (NR212) (see also FIG. 12 microporous layer MPL). The area-specific resistance (ASR), i.e. the slope of the polarization curve, increases due to the additional ohmic loss (FIG. 10a) as expected, thus reducing voltaic efficiency (FIG. 10b). In contrast, coulombic efficiency is improved due to reduced crossover, especially at low current density, where crossover has the largest impact. These competing effects lead to a loss of energy efficiency at high current density, and an improvement at low current density. The maximum energy efficiency achieved is increased from 75% to 80% via addition of the microporous membrane. The transport properties of the chosen PEM and microporous separator, as well as thickness and porosity of the microporous separator, could be optimized to increase the overall performance of a specific system. The tradeoff between ohmic loss and reduced crossover is expected to be a universal feature of any such dual membrane cell design.

### 3.7 Long-Term Cycling

Long-term operation of a cell was performed to assess durability of cell active materials and monitor evolution of the membrane properties over time. The MEA used for cycling was NR212 membrane with carbon (+) and Pt/Carbon (−) catalyst layers deposited on the membrane, as this configuration was shown to have the highest performance in our previous work. The MEA was pretreated by soaking in 70° C. water to increase efficiency as discussed above in Section 3.4. The cell was assembled with the membrane in the wet/swelled state.

Although selection of membrane type and pretreatment can reduce crossover, transport of water and bromine-species through the membrane during operation cannot be eliminated. As discussed above, net flux over a whole charge/discharge cycle is towards the (−) electrode, where all bromine species are reduced to bromide. A practical system must not accumulate water or bromide in the (−) electrode chamber or hydrogen tank in order to avoid loss of active material from the catholyte, contamination or dissolution of the (−) Pt due to high Br⁻ concentration, and complication of mechanical hydrogen compression in the case of high-pressure gas storage. Our previous work assessed various mechanisms for mechanical return of the crossover liquid to the catholyte tank, finding that condensing liquid from the hydrogen exhaust and pumping it to the catholyte tank provided the best short-term capacity retention by minimizing evaporative loss of bromine from the system. Here, that system was modified to include hydrogen capture and storage to allow long-term cycling in true battery mode (closed system as opposed to continuously venting hydrogen from the cell exhaust).

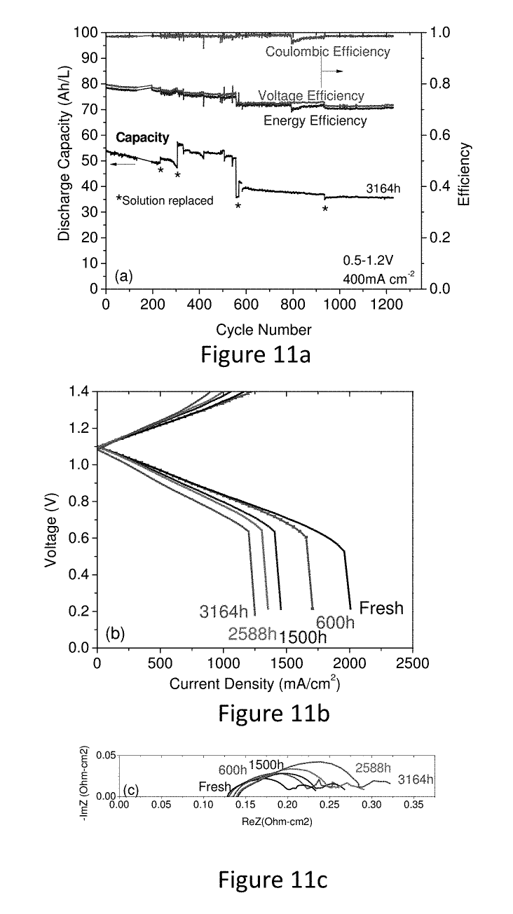

FIG. 11a shows efficiency and capacity during 3164 h of cycling (1230 cycles) at 400 mA cm⁻². Initial coulombic efficiency was 98.5%, consistent with the low bromine crossover observed above for this membrane pretreatment. The coulombic efficiency was very stable, as the self-discharge rate did not vary much with cycling (see Table 3). Initial voltage and energy efficiency were 79 and 78%, respectively. These efficiencies are comparable to those reported at much lower current density (i.e. 30 to 100 mA cm⁻²) for the vanadium redox flow battery. The voltaic efficiency decreased slowly over time, causing the energy efficiency to decrease as well. Capacity loss arises from two main causes: slow loss of bromine from the system via very small leaks observed at the cell hardware; and, decreased utilization resulting from the voltage cutoffs being engaged earlier due to increased cell impedance. The catholyte solution was replaced periodically, but there is capacity decay, suggesting the latter cause dominates. Nevertheless, this is a substantial improvement over our previous long-term cycling results where a more rapid capacity decay resulting from evaporative loss of bromine in the hydrogen exhaust was observed.

The causes of voltaic-efficiency loss were elucidated by recording cell polarization performance and impedance periodically (FIG. 11b-c). Fresh electrolyte solution was used, to avoid complication from electrolyte solution changes during cycling; hydrogen pressure was ambient during all polarization tests. The cell ASR increases continuously during cycling. AC impedance (FIG. 11c) reveals that this is due to increases in both ohmic and electrode polarization. We presume that the ohmic impedance increase is due to reduced membrane ionic conductivity, as contact resistances and electronic conductivity of the cell components are not expected to change significantly. The membrane conductivity reported in Table 3 is calculated assuming the non-membrane resistance measured before cycling (0.055 Ohm-cm²) does not change. The decrease in limiting current is consistent with a loss of active electrocatalyst area at the (−) electrode. The limiting current occurs when bromide adsorption on the (−) electrode blocks enough Pt active sites to constrain the hydrogen reduction rate. Therefore, the limiting current can be reduced by a decrease in hydrogen concentration, increase in brominde concentration, or reduction of Pt active area at the (−) electrode. The bromine-species crossover rate generally decreased with cycling (Table 3), and the crossover liquid is continuously flushed from the (−) electrode, so it is expected that the average bromide concentration at the Pt surface decreased with cycling. Loss of Pt active area, via deactivation or dissolution is therefore the most likely cause. ICP analysis of the catholyte indicated minimal Pt dissolution. Solutions used from 0 to 600 h and 1725 to 2588 h showed 4.2 and 2.7 ng h⁻¹ cm⁻² Pt loss, respectively, from the electrode. This suggests less than 3% of the original 4 mg total Pt content of the (−) electrode was dissolved during the entire period of cycling operation. Therefore, we suspect that other electrode changes such as adsorption of bromide on Pt, reduction of active area due to localized flooding, or changes in GDL surface chemistry at the (+) electrode also contribute to the increased electrode polarization evident in FIG. 11c.

Membrane properties were assessed when the catholyte was replaced, and are reported in Table 3. It is clear that all properties evolve with cycling time. Transport of protons (conductivity), bromine species, and water all decrease upon cycling. Some recovery occurred at the end of cycling (2588 to 3164 h), although it is not yet clear whether this is indicates a long-term trend. The initial improvement offered by pre-treating the membrane in 70° C. water evolves upon cycling, however, the transport properties remain significantly higher than for as-received membrane (see Table 1).

TABLE 3
Evolution of selected membrane properties with cycling
for a cell with NR212 pretreated by soaking at 70° C.

| | | | | Electro-osmotic | | | |
|---|---|---|---|---|---|---|---|
| | | | | Coefficient | Br/H⁺ | Br/H₂O | Self- |
| | Conductivity | Water Flux | Br Flux | H₂O/H⁺ | (mmol | (mmol | Discharge |
| | (mS cm⁻¹) | (mg h⁻¹ cm⁻²) | (mg h⁻¹ cm⁻²) | (mol mol⁻¹) | mol⁻¹) | mol⁻¹) | (mA cm⁻²) |
| Cycling Fresh | 77 | 600 | 24 | 1.8 | 16 | 9 | 3.7 |
| Cycling 600 h | 76 | 548 | 21 | 1.6 | 14 | 9 | 3.5 |
| Cycling 1500 h | 66 | 503 | 19 | 1.5 | 12 | 8 | 3.0 |
| Cycling 2588 h | 67 | 530 | 18 | 1.6 | 12 | 8 | 3.3 |
| Cycling 3164 h | 71 | 658 | 24 | 2.0 | 16 | 8 | 3.5 |

### SUMMARY

The effect of various aspects of material selection, processing, and assembly of proton-exchange membranes (PEMs) on the operation of the Br₂/H₂ redox flow cell was determined. Membrane properties have a significant impact on the performance and efficiency of the system. High conductivity of the membrane is necessary for good cell polarization performance, whereas low bromine-species crossover is critical to minimize self-discharge and maintain high coulombic and energy efficiencies. There is, however, a fundamental tradeoff between conductivity and crossover, which is illustrated by the impact of various membrane features including thickness, pretreatment procedure, swelling state during cell assembly, equivalent weight, membrane reinforcement, and addition of a microporous separator layer. Performance and efficiency are most sensitive to membrane thickness, pretreatment procedure, and swelling state. NR212 (50 μm thick) pretreated by soaking in 70° C. water was found to be optimal. The impact of equivalent weight and membrane reinforcement was much less significant. Insertion of a microporous separator between the bromine solution and membrane was effective at reducing crossover, but at the expense of polarization performance, thereby showing increased efficiency only at low current density. The membrane swelling state (extent of hydration) during cell assembly impacts membrane transport properties via mechanical constraint of the in-operation swelling. For as-received membranes, it is desirable to wet them before cell assembly, whereas pre-boiled membranes should be dried to ambient conditions before cell assembly.

Significant crossover of water and bromine-species from the (+) to (−) side was found to occur during charge and at open-circuit. Crossover during open-circuit was more pronounced at high SOC, which may impact operation protocol optimization when the system experiences long hold times between charge and discharge events. The crossover rate was highly dependent on current density, indicating that electro-osmosis dominates over permeation and diffusion. During discharge, minimal crossover occurred as electro-osmosis counteracted permeation and diffusion fluxes.

Continuous cycling for 3164 h at high energy efficiency (72-78%) at 400 mA cm⁻² was achieved, with continuous return of crossover liquid to the electrolyte tank and recirculated hydrogen (self-contained battery mode) and a membrane pretreated at 70° C. Membrane transport properties, including conductivity and bromine and water crossover, were found to decrease moderately upon cycling but remained higher than those for the as-received membrane over the duration tested here.

Characterization of membrane materials for the hydrogen-bromine redox flow battery solely by polarization performance is insufficient. Efficiency must also be determined, as high performance is often coupled with high crossover which reduces coulombic efficiency.

Furthermore, performance and crossover vary with SOC so full-cycle data is required to characterize accurately the merit of a membrane material or cell design. The results presented here indicate that development of improved membranes with increased conductivity and reduced crossover of water and bromine-species is an area for fruitful research, and with the possibility to improve performance and efficiency significantly.

### Membranes for High Efficiency Operation of Redox Flow Cells

All examples are demonstrated with the bromine-hydrogen redox flow cell, but the invention is broadly applicable to all redox flow cells, fuel cells, electrolyzers, and electrochemical reactors.

FIG. 12 illustrates a typical bromine-hydrogen cell structure. The horizontal dimensions are to scale, and typical membrane thickness is 50 μm.

Aqueous redox flow cells typically comprise a PEM (proton exchange membrane) that: (a) prevents short-circuit between the (+) and (−) electrodes, (b) provides a path for proton conduction, and (c) undesirably allows crossover of water, active species, and spectator species. It is desirable to increase proton conduction (reduce membrane resistance) and reduce crossover. However, both transport properties generally increase or decrease together in response to membrane modification or treatment. This presents a trade-off, and the goal is to implement membrane modifications that improve one property more than the other is sacrificed, thereby increasing selectivity and efficiency.

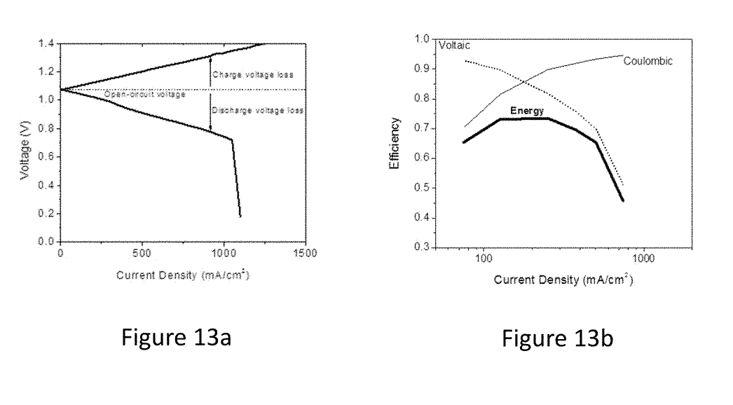

FIG. 13a and FIG. 13b illustrate a typical performance and efficiency behavior of the bromine-hydrogen redox flow cell. The efficiencies are determined over full charge/discharge cycles at various current densities. The total energy efficiency (which dictates energy storage merit of the system) is the product of voltaic and coulombic efficiencies. The voltaic efficiency corresponds to the electrochemical voltage losses in the cell; driving high current produces high voltage loss and therefore low voltaic efficiency. The membrane resistance is a large contributor to voltage losses, so improving proton conduction of the membrane increases voltaic efficiency. Coulombic efficiency is the ratio of discharge energy to charge energy stored in the system. Ideally, this can approach unity, but in this system there is a significant self-discharge arising from bromine crossover. Bromine crosses through the membrane and is reduced at the (−) electrode without generating useable electricity. A portion of the bromine is used to create electricity, and a portion is consumed by self-discharge, but all bromine must be re-charged. Therefore, there is less discharge energy available compared to the energy required to fully charge the system. The coulombic efficiency is better at high current because the self-discharge (crossover) rate becomes relatively smaller than the external current.

Various embodiments of the invention provide for membranes and membrane treatments that enable improved energy efficiency via reduced crossover, increased conductivity, or both. In other words, the structures and methods of various embodiments of the invention influence the trade-off between crossover and conductivity beneficially for overall system efficiency. None of the embodiments is expected to increase cost significantly. Various embodiments of the invention also enable reduced membrane stress, improved durability, and long cell lifetime. Therefore, various embodiments of the invention are expected to make redox flow cell energy storage systems more economically attractive.

### Embodiment 1. Optimized Pretreatment

Membranes are typically used “as-received” from the manufacturer, or “pre-boiled”. Pre-boiling consists of boiling the membrane successively in mild hydrogen peroxide, water, dilute sulfuric acid, and water again (or a subset of these). It is known that preboiling increases proton transport (reduces membrane resistance), at the expense of increasing undesirable crossover of other active species and water during cell operation.

Various embodiments of the invention have determined that an intermediate pretreatment of soaking the membrane in hot water (below the boiling point) reduces membrane resistance almost as much as boiling, but with dramatically lower crossover. This results in improved energy efficiency at all current densities compared to use of pre-boiled membrane, and at high current densities compared to as-received membranes (see FIG. 7c). In one embodiment, for example, soaking is performed at 70° C. in water. In other embodiments, soaking is performed at a wide temperature range (40-95° C. or 50-80° C. or preferably 60-80° C.) and also results in improved results.

### Embodiment 2. Swelling State During Assembly

Membranes swell when they are wetted, and shrink when dried. Swelling increases proton transport (reduces membrane resistance), at the expense of increasing undesirable crossover of other active species and water during cell operation.

We find that during cell assembly, the physical in-plane size of the membrane is locked in by compressing the membrane between gaskets. This prevents the membrane from swelling/shrinking even if the membrane is wetted or dried during later cell operation. Therefore, whether the membrane is wet or dry at the cell assembly step has an impact on cell performance and efficiency. This effect does not appear to be taught in the prior art.

For the case of un-reinforced membrane, the swelling can be significant (5-20%) upon wetting. For an as-received membrane, it is preferred to wet it before cell assembly to yield improved conductivity. In contrast, for a pre-boiled membrane it is preferred to dry it before cell assembly to greatly reduce crossover.

Another way to control/constrain swelling is to laminate the membrane to the electrode (which does not shrink/swell) before assembly.

### Embodiment 3. Dual Membrane

The rate of undesirable crossover of bromine species is directly related to the bromine concentration available at the (+) electrode side of the membrane. For example, using less bromine in the solution is known to reduce crossover, but at the expense of total capacity.

Various embodiments demonstrate inserting a diffusion barrier between the membrane and (+) electrode or solution flow path can reduce crossover, and therefore improve coulombic efficiency. If this is done in such a way as to minimize the voltaic efficiency loss (arising from longer conduction path), an overall gain in energy efficiency can be achieved. The diffusion barrier imposes a concentration gradient between the bulk solution concentration and the (+) face of the membrane, thus lowering the bromine concentration available at the membrane and reducing crossover.

FIG. 12a illustrates a bromine-hydrogen cell structure. FIG. 12b illustrates a bromine-hydrogen cell structure further comprising a diffusion barrier layer. The diffusion barrier layer comprises any inert, porous material, or can simply be a gap between the electrode and the membrane. Suitable materials include microporous polymer separator, porous ceramic, porous metal, porous carbon, paper, mesh, etc. The example discussed above demonstrates the effect with Daramic-brand microporous separator. The diffusion barrier may comprise any one of or at least one of Daramic, Celgard, Millipore, Amer-sil, or Durapore.

Various embodiments may comprise reactants comprising at least one of zinc (Zn), vanadium (V), cerium (Ce), or iron (Fe) and species thereof. For example, Ce/Zn, Br/Zn, Fe/Cr, V/V, Fe/Fe, (different oxidation states of V or Fe on each side).

For iron (Fe) and species thereof, other reactant combinations may include Fe₂(SO₄)₃:H₂SO₄, FeCl₃:HCl.

For example, for iron (Fe):

Fe(III)X₃->Fe(II)X₂+HX

Fe(III)NO₃+H⁺+e⁻¹->Fe(II)(NO₃)₂+HNO₃

Various embodiments may comprise an ion exchange membrane (IEM) redox flow cell comprising a IEM, a negative electrode in contact with a reactive fluid, a liquid electrolyte comprising reactants, a positive electrode in contact with the liquid electrolyte, and a diffusion barrier layer disposed between the IEM and the positive electrode, and wherein the negative electrode is isolated from the positive electrode by the IEM. The IEM redox flow cell, wherein the reactive fluid is a hydrogen gas. The IEM redox flow cell, wherein the reactants comprise Br₂ and HBr. The IEM redox flow cell, wherein the positive electrode comprises carbon paper. The IEM redox flow cell of, wherein the diffusion barrier layer comprises at least one of Daramic, Celgard, Millipore, Amer-sil, or Durapore. The IEM redox flow cell, wherein a catalyst layer is in contact with the PEM on the negative electrode side of the PEM. The IEM redox flow cell of claim 1, wherein a catalyst layer is in contact with a microporous layer on the negative electrode side of the PEM. The IEM redox flow cell of, wherein a gas diffusion layer is disposed on the negative electrode side of the PEM. The IEM redox flow cell, wherein IEM comprises a proton exchange membrane (PEM). The IEM redox flow cell of claim 1, wherein IEM comprises a anion exchange membrane (AEM). The IEM redox flow cell of, wherein the diffusion barrier layer is configured to maximize cell round-trip energy efficiency. The IEM redox flow cell, wherein the reactants comprise at least one of zinc (Zn), vanadium (V), cerium (Ce), or iron (Fe) and species thereof.

What is claimed is:

1. An ion exchange membrane (IEM) redox flow cell comprising:
a IEM;
a negative electrode in contact with a reactive fluid;
a liquid electrolyte comprising reactants;
a positive electrode in contact with the liquid electrolyte; and
a diffusion barrier layer disposed between the IEM and the positive electrode, and wherein the negative electrode is isolated from the positive electrode by the IEM.

2. The IEM redox flow cell of claim 1, wherein the reactive fluid is a hydrogen gas.

3. The IEM redox flow cell of claim 1, wherein the reactants comprise Br₂ and HBr.

4. The IEM redox flow cell of claim 1, wherein the positive electrode comprises carbon paper.

5. The IEM redox flow cell of claim 1, wherein the diffusion barrier layer comprises at least one of Daramic, Celgard, Millipore, Amer-sil, or Durapore.

6. The IEM redox flow cell of claim 1, wherein a catalyst layer is in contact with the PEM on the negative electrode side of the PEM.

7. The IEM redox flow cell of claim 1, wherein a catalyst layer is in contact with a microporous layer on the negative electrode side of the PEM.

8. The IEM redox flow cell of claim 1, wherein a gas diffusion layer is disposed on the negative electrode side of the PEM.

9. The IEM redox flow cell of claim 1, wherein IEM comprises a proton exchange membrane (PEM).

10. The IEM redox flow cell of claim 1, wherein IEM comprises a anion exchange membrane (AEM).

11. The IEM redox flow cell of claim 1, wherein the diffusion barrier layer is configured to maximize cell round-trip energy efficiency.

12. The IEM redox flow cell of claim 1, wherein the reactants comprise at least one of zinc (Zn), vanadium (V), cerium (Ce), or iron (Fe) and species thereof.
